(19) United States
(12) Patent Application Publication
(10) Pub. No.: US 2012/0228212 A1
(43) Pub. Date: Sep. 13, 2012

(54) Asymmetric Carbon Block System and Method

(75) Inventors: Ken K. Jian, Thiensville, WI (US); Thomas W. Clarke, Sheboygan, WI (US)

(73) Assignee: Pentair Residential Filtration, LLC, Golden Valley, MN (US)

(21) Appl. No.: 13/043,316

(22) Filed: Mar. 8, 2011

(51) Int. Cl. B01D 27/00; C01B 31/08

(52) U.S. Cl. 210/483; 502/416

(57) ABSTRACT

Some embodiments of the invention provide an asymmetric activated carbon block comprising at least a first element and a second element. In some embodiments, the first element can comprise at least two constituents and the second element can comprise at least two constituents. In some embodiments, at least a portion of the first element can be positioned within the second element and at least one of the at least two constituents of the first element can differ from at least one of the at least two constituents of the second element. In some embodiments, the first element and the second element can be asymmetric with respect to a structural property. Some embodiments include part of the first element being located immediately adjacent the second element.

### BACKGROUND

Activated carbon can be used for as an effective treatment medium in fluid and waste-fluid treatments, for example as granular activated carbon or activated carbon blocks. Activated carbon blocks improve the aesthetic look of fluid as well as reduce or remove turbidity, taste, odor, and some other contaminants.

Conventional activated carbon blocks can be symmetric in cross section, with respect to both structure and composition, which can cause shortened service lifespan and generally reduced separation efficiency. The symmetry in structure can cause deterioration in treatment capacity because of clogging and fouling of the carbon blocks. As a result of the clogging and fouling, the blocks can quickly reach maximum deterioration and lose the ability to treat before reaching their designed treatment capability. Additionally, for some symmetric blocks, unwanted interactions can occur between contaminants and portions of the symmetric blocks, which also can impact lifespan and efficiency.

### SUMMARY

Some embodiments of the invention provide an asymmetric activated carbon block comprising at least a first element and a second element. In some embodiments, the first element can comprise at least two constituents and the second element can comprise at least two constituents. In some embodiments, at least a portion of the first element can be positioned within the second element and at least one of the at least two constituents of the first element can differ from at least one of the at least two constituents of the second element. In some embodiments, the first element and the second element can be asymmetric with respect to a structural property. Some embodiments include part of the first element being located immediately adjacent the second element.

Some embodiments of the invention provide a block element combination method for treating a fluid. In some embodiments, the method comprises determining an identity of at least some contaminants in the fluid and then selecting constituents that can treat a portion of the fluid to remove a portion of the contaminants. Further, some embodiments provide determining a treatment sequence, and then independently manufacturing a first element and a second element from the constituents, wherein at least one of the constituents of the first element and the constituents of the second element is different.

Some embodiments of the invention provide an asymmetric activated carbon block comprising a first element including a first treatment profile. The first element can include a first element channel. Some embodiments provide a second element comprising a second treatment profile and the second element can include a second element channel. A portion of the first element can be positioned within the second element channel of the second element, and the first treatment profile and the second treatment profile can be different.

### DESCRIPTION OF THE DRAWINGS

FIG. 1A is a cross-sectional view of an asymmetric activated carbon block according to one embodiment of the invention.

FIG. 1B is a cross-sectional view of an asymmetric activated carbon block according to one embodiment of the invention.

FIGS. 2A and 2B are representative graphs based on results from experiments conducted on asymmetric activated carbon blocks according to some embodiments of the invention.

FIGS. 3A-3G are representative graphs based on results from experiments conducted on asymmetric activated carbon blocks according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

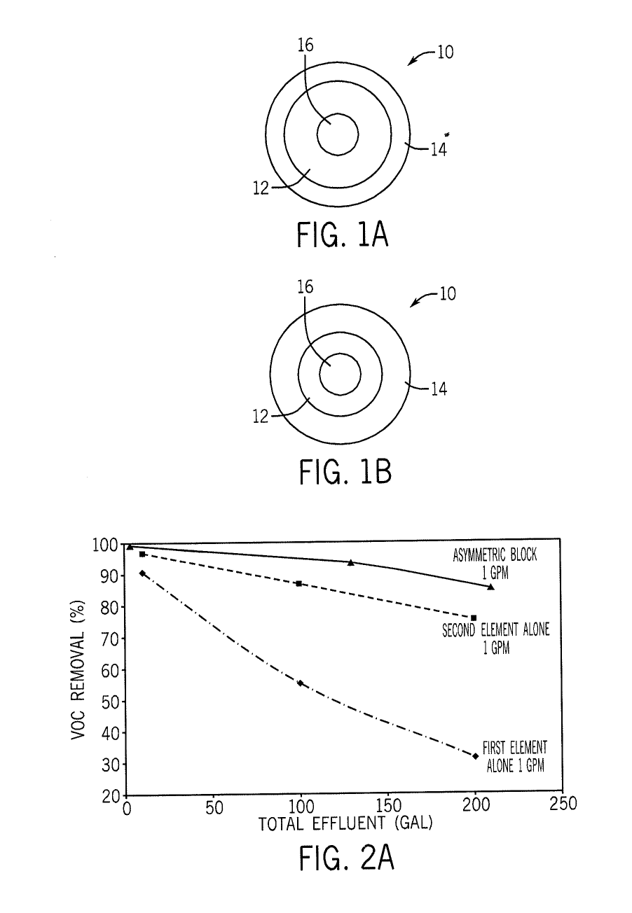

FIGS. 1A and 1B illustrate an activated carbon block 10 according to one embodiment of the invention. The block 10 can include an asymmetric composition and/or structure by including at least a first block element 12 and a second block element 14. In some embodiments, more than the first block element 12 and the second block element 14 can comprise the block 10, such as, a third and a fourth block element (not shown). More specifically, from a cross-sectional view of the block 10, the structure and/or composition can be substantially asymmetric (i.e., non-uniform).

In some embodiments, the activated carbon block 10, the first block element 12, and the second block element 14 can comprise a generally cylindrical shape, although in other embodiments, the block 10 and the elements 12, 14 can comprise other shapes, including, but not limited to circular, square, rectangular, regular or irregular polygonal, or other shapes. Although later references to the block 10 and the elements 12, 14 may suggest cylindrical properties (i.e., “circumference,” “inner diameter,” “outer diameter,” etc.), these components can comprise many different shapes.

In some embodiments, the block 10 can treat contaminants in a fluid, such as water. In some embodiments, treating contaminants can comprise treating, chemically and/or physically neutralizing, adsorbing, absorbing, or other actions which can remove or reduce contaminants, pollutants, and impurities from a fluid. For example, in some embodiments, the contaminants can comprise small and large particulate matter, cysts, volatile organic compounds (VOCs), endocrine disrupters, cancer-causing disinfection by-products, heavy metals, MTBE (methyl tert-butyl ether), chloramines, asbestos, other materials, and any combination thereof. In some embodiments, either one of, or both of the elements 12, 14 can comprise at least one of mechanical filtration capabilities, electrokinetic adsorption capabilities, physical adsorption capabilities, and other filtering, treating, and/or purifying capabilities.

In some embodiments, the block 10 and the elements 12, 14 can comprise different constituents depending on the treatment requirements. For example, in some embodiments, the elements 12, 14 can comprise activated coal carbon, which can enhance halogen and organics removal; coconut carbon, which can enhance VOC removal; zinc-copper alloys, which can at least partially catalyze oxidation-reduction reactions to enhance removal of iron, halogens, sulfides, heavy metals, as well as aid in controlling the growth of microorganisms; ion-exchange sorbant, which can enhance heavy metal removal, small size carbon, which can enhance cyst and VOC removal; inorganic filler, which can enhance cyst removal; zeolite, which can enhance adsorption, ion-exchange, neutralization of ammonia/ammonium, and removal of hydrocarbons, heavy metals, and radium; polymer resin binding and/or a ceramic binder, which can bind together other constituents of the elements 12, 14, or any combination thereof. Additionally, other compounds can serve as constituents of the elements 12, 14 that comprise similar treating, filtering, cleaning, and/or purifying capacities, such as diatomaceous earth and other forms of carbon, including wood carbon, fish bone carbon, bovine carbon, bamboo, and other categories of carbon. Further, in some embodiments, the first element 12 and the second element 14 can each comprise at least two constituents, although the constituents need not be the same.

In some embodiments, the elements 12, 14 can be manufactured by different processes. More specifically, in some embodiments, the elements 12, 14 can be extruded. For example, several of the previously mentioned constituents can be selected, as described in more detail below, combined in an extruder, and can be extruded to form a pre-selected size and shape. In some embodiments, the first element 12 and the second element 14 can be co-extruded using a main extruder and at least one satellite co-extruder. In some embodiments, the first element 12 and the second element 14 can be extruded on at least two different extruders or can be extruded on the same extruder, but at different times. Furthermore, in some embodiments, the constituents of the first element 12 and the second element 14 can be combined in at least two separate vessels and then the first element 12 and the second element 14 can be molded into a desired shape and size. In some embodiments, the elements 12, 14 also can be manufactured through processes such as sintering or general use of adhesives, such as gluing. In some embodiments, sintering can include general sintering, ceramic sintering, sintering of metallic powders, plastics sintering, fluid phase sintering, and other similar forms of sintering. Also, in some embodiments, the first element 12, the second element 14, and any other elements comprising the block 10 can each be manufactured by different processes (i.e., the first element 12 can be extruded and the second element 14 can be molded or vice versa). Further, in some embodiments, the two elements 12, 14 can be made by both different processes and/or at substantially different times (i.e., the manufacturing of one of the elements can be independent of the manufacturing of the other element).

After manufacturing the elements 12, 14, the first element 12 can be inserted into the second element 14 so that at least a part of the first element 12 can be immediately adjacent to the second element 14. By way of example only, in some embodiments, both the first element 12 and the second element 14 can be formed, by extrusion, molding, or other manufacturing processes, so that the elements 12, 14 comprise a first element channel 16 and a second element channel (not shown). In some embodiments, an inner diameter of the second element 14 can comprise a diameter that is substantially the same as an outer diameter of the first element 12. As a result, at least a portion of the first element 12 can be inserted into and positioned substantially within the element channel of the second element 14 and the two elements 12, 14 can be in close contact (i.e., the inner diameter of the second element 14 can be located immediately adjacent to the outer diameter of the first element so that the two elements 12, 14 are substantially contiguous). In some embodiments, the entire first element 12 can be inserted into the second element 14 so that the outer diameter of the first portion 12 is immediately adjacent to the inner diameter of the second element 14.

In some embodiments, after inserting the first element 12 inside the second element 14, the two elements 12, 14 can coupled together. For example, in some embodiments, the two elements 12, 14 can be interference-fit together, press-fit together, heat bonded together, or other similar bonding and/or coupling methods. In some embodiments, after inserting the first element 12 into the second element 14, portions of distal ends (not shown) of the element 12, 14 and/or block 10 can be substantially sealed. In some embodiments, the distal ends can be substantially sealed using end caps coupled to the distal ends. More specifically, in some embodiments, an adhesive, such as a hot glue, can be applied to the distal ends of the elements 12, 14, and the end caps can then be affixed to the distal ends so that portions of the distal ends are substantially sealed. In some embodiments, the end caps need not comprise the same structure. In other embodiments, portions of the distal ends can be substantially covered in a sealant so that portions of the distal ends are substantially sealed.

In some embodiments, after substantially sealing portions of the distal ends, the block 10, including the first element 12 and the second element 14, can be inserted into a cartridge (not shown). In some embodiments, the cartridge can comprise a similar shape as the block 10 (i.e., for a substantially cylindrical block, the cartridge also comprises a substantially similar shape). Also, in some embodiments, the cartridge can include an open end and a closed end. More specifically, in some embodiments, a portion of the block 10 can be inserted into the cartridge through the open end.

In some embodiments, after inserting the block 10, the closed end can substantially support the block 10 and the end cap coupled to the distal end of the block 10 proximal to the open end of the cartridge can comprise a fluid-permeable end cap. Additionally, in some embodiments, a cartridge end cap (not shown) can be coupled to the open end of the cartridge to at least partially close the cartridge. In some embodiments, the fluid-permeable end cap can include a fluid aperture, which, in some embodiments, can be in fluid communication with the element channel 16 of the first element 10. In some embodiments, the fluid-permeable end cap and the cartridge end cap can be coupled to a fluid circulatory system that can be used for the influx and efflux of the fluid to and from remote locations, relative to the cartridge.

According to some embodiments of the invention, the cartridge, including the block 10, can substantially filter and/or treat a portion of the contaminants contained in fluids, such as water. In some embodiments, the fluid circulatory system can pressurize and transport the fluid from a remote location and direct portions of the fluid into the cartridge, through the cartridge end cap, and toward the radial edges of the block 10. More specifically, the block 10 end caps can substantially prevent a material amount of fluid from entering the block 10 other than at the radial edges of the block 10. In some embodiments, because the fluid is pressurized, the fluid can be directed radially inward through the block 10. For example, as the fluid flows through the second element 14, a portion of the contaminants can be removed from the fluid through different processes (i.e., adsorption, absorption, chemical process, etc.). Then, in some embodiments, as the fluid flows through the first element 12, another portion of the contaminants can be removed from the fluid through the same, similar, or different processes than previously mentioned with respect to the second element 14.

In some embodiments, after flowing through the second element 14 and the first element 12, a portion of the fluid can enter the element channel 16 of the first element 12. As previously mentioned, the element channel 16 of the first element 12 can be in fluid communication with the fluid aperture of the fluid-permeable end cap, which is in fluid communication with the fluid circulatory system. As a result, in some embodiments, at least a portion of the pressurized fluid, after flowing through the second element 14 and the first element 12 can re-enter the fluid circulatory and be transported to a remote location with substantially fewer contaminants. Additionally, in some embodiments, the fluid circulatory system can comprise more than one cartridge. More specifically, in some embodiments, a plurality of cartridges can be connected to the fluid circulatory so that the plurality of cartridges are substantially arranged in series or another configuration to further enhance contaminant removal. Further, in some embodiments, the cartridges can include blocks 10 substantially similar to those previously mentioned, but in other embodiments, the cartridges can include blocks 10 with compositions that differ from previously mentioned.

According to some embodiments of the invention, the block 10 can include asymmetric properties. More specifically, in some embodiments, the first element 12 can comprise a first treatment profile and the second element 14 can comprise a second treatment profile. For example, in some embodiments, the first and the second treatment profiles can comprise asymmetric structures and/or an asymmetric compositions of the elements 12, 14. Through this asymmetry, treating functions of the block 10 can be separated into and implemented by the elements 12, 14. The first treatment profile and the second treatment profile can comprise the structure, composition, and other attributes of the elements 12, 14, which can influence treatment of contaminants. In some embodiments, by the first element 12 comprising the first treatment profile and the second element 14 comprising the second treatment profile, some inadequacies associated with conventional activated carbon blocks, such as pore clogging, carbon particle fouling, and low separation performance can be improved. The different treatment profiles also can permit a combination of block elements that can include substantially different separation properties and processing characteristics. As a result, in some embodiments, the activated carbon block 10 can enhance complicated and difficult treatment requirements.

According to some embodiments of the invention, treatment profiles, and as a result, the elements 12, 14 and the block 10, can comprise an asymmetric structure. For example, in some embodiments, the elements 12, 14 can include different structural properties which can enhance fluid treatment. More specifically, in some embodiments, because the first element 12 and the second element 14 can be manufactured using different processes and/or at different times, as previously mentioned, the elements 12, 14 can comprise different structural properties, such as size, density, mass, and other similar attributes.

In some of the embodiments, manufacturing conditions can at least partially influence the structural properties. For example, manufacturing conditions such as the pressure, the temperature, and the speed of the extruder and any co-extruders used to manufacture the elements 12, 14 can be different depending on the constituents and the desired structural properties. For example, in some embodiments, to manufacture the first element 12, the extruder screw can be set to a high speed to substantially mix the constituents of the first element 12, and the extruder screw can be set to a relatively low back-pushing pressure to extrude the first element 12 through a die. Then, in some embodiments, to manufacture the second element 14, the extruder screw can be set to a substantially low speed and a relatively high back-pushing pressure to extrude the second element 14 through the die. Additionally, the temperature of the extruder can differ depending on the desired properties of the elements 12, 14. As a result, the elements 12, 14 can comprise different physical properties such as a shrinkage ratio after manufacturing, density, pore size, element dimensions, and other physical properties. For example, in some embodiments, as previously mentioned, the outer diameter of the first element 12 can be substantially the same as the inner diameter of the second element 14, so that the first element 12 can comprise lesser element dimensions, including lesser element inner and outer diameters.

According to some embodiments of the invention, treatment profiles, and as a result, the elements 12, 14 and the block 10, can comprise an asymmetric composition. More specifically, the first element 12 and the second element 14 can comprise different constituents that can include different fluid treatment capabilities. For example, in some embodiments, the first element 12 can comprise constituents that can treat certain contaminants in some fluids, and the second element 14 can comprise constituents that can treat the same contaminants and/or different contaminants, relative to the first element 12.

Furthermore, in some embodiments, some aspects of the asymmetric compositions and the asymmetric structure can be interconnected. More specifically, in some embodiments, the different compositions can comprise different physical properties. As a result, in some embodiments, the composition of the first element 12 can lead to manufacture in a method that can substantially differ from, and can be generally independent of, the manufacture method of the second element 14 largely because of differences in composition between the two elements 12, 14. By way of example only, in some embodiments, the first element 12 can include constituents which can be extruded at elevated temperatures, however the second element 14 can include constituents which can be generally non-amenable to extrusion so that the second element 14 may need to formed by molding at significantly higher temperatures.

In some embodiments, the performance and range of applications of activated carbon blocks can be greatly enhanced and extended by providing asymmetry in the compositions. The asymmetric compositions can enhance treatment in at least two manners. First, in some embodiments, some of the constituents of the elements 12, 14 can be localized to only some regions of the block 10. For example, a constituent which can enhance treatment of fluids for certain contaminants can be added to either one of, or both of the elements 12, 14 during manufacture. In some embodiments, this can increase the concentration of the chosen constituents in the elements 12, 14 relative to blocks not employing similar manufacturing processes. As a result, in some embodiments, larger constituent concentration can lead to enhancing the treatment performance and/or reducing the necessary amount of expensive constituents.

Second, in some embodiments, the numbers of combinations of different elements 12, 14 can vary to be more closely tailored to end user treatment requirements. For example, in some embodiments an asymmetric block 10 can be formed by the combination of an extruded first element 12 including a first set of constituents and a molded non-carbon second element 14 including a second set of constituents, which can expand the application area of the blocks. Additionally, in some embodiments, by employing elements 12, 14 comprising at least two different constituent compositions, one block 10 can remove contaminants with increased efficiency, can incorporate more treating media, and can remove a generally larger spectrum of contaminants, relative to blocks containing fewer and/or less efficient constituents.

According to some embodiments of the invention, a block element combination method can enhance the fluid treatment process. More specifically, in some embodiments, the fluid treatment process can comprise determining objects of the fluid treatment and which treatment profiles, and accordingly, which constituents, can be employed to achieve the objects; designing a treatment sequence and other treatment parameters; manufacturing of the elements using the pre-determined constituents; and assembly of the block and cartridge. In some embodiments, the method need not comprise the previously mentioned order and can be ordered to meet particular user and/or manufacturer needs.

In some embodiments, a manufacturer, end user, or other parties can determine the objects of the fluid treatment and which treatment files can be employed to achieve the objects. In some embodiments, operation of block 10 can be substantially enhanced if the constituents of the block 10 comprise materials which can treat the fluid (i.e., remove a portion of the contaminants). More specifically, determining the objects of the fluid treatment can include initially determining which contaminants, pollutants, and other impurities the fluid can include. In some embodiments, the objects of the invention can already be known to a user and/or manufacturer, and accordingly, this step can be omitted. Then, the manufacturer and/or end user can determine which treatment profiles, and as a result, which constituents, can suitably treat the fluid to remove at least a portion of the contaminants. By way of example only, in some embodiments, a fluid, such as water, can include impurities such as chlorine, VOCs, lead, cysts, and other particulates. After determining the identity of the contaminants, a user can determine which constituents can be treat the fluid. For example, in the case of the previously mentioned contaminants, some constituents which can enhance removal can include coal carbon, coconut carbon, ion-exchange sorbent, small-size carbon, an inorganic filler, and a polymer resin binder to bind together the constituents.

In some embodiments, after determining the object of the treatment and which treatment profiles can be employed to achieve the object, a treatment sequence and other treatment parameters can be determined. As previously mentioned, in some embodiments, the fluid can enter the block through an outer-most radial edge of the second element 14 and flow radially inward toward the element channel 16 of the first element 12. The order in which the fluid contacts the constituents and under what conditions can lead to enhanced treatment. Further, depending on the contaminants, density and other structural properties also can be determined for enhanced treatment. Additionally, in some embodiments, by pre-determining the treatment sequence and the structural properties, some contaminants can be substantially removed from the fluid before those contaminants can chemically and/or physically react with some constituents. As a result, by determining a generally effective treatment sequence and structural properties, treatment can be enhanced.

For example, for a fluid comprising the contaminants mentioned above, the second element 14 (i.e., the more radially outward element in some embodiments) can comprise the coal carbon and the polymer resin binder because the coal carbon can adsorb portions of both chlorine and VOCs without competition between the two contaminants for adsorption sites within the coal carbon, which, in some embodiments, can also generally reduce competition between the two contaminants for adorption sites within the first element 12. Further, the first element 12 can comprise the coconut carbon, the ion-exchange sorbent, the small-size carbon, the inorganic filler, and the polymer resin binder. In some embodiments, because portions of the chlorine can chemically react with the ion-exchange sorbent, causing less effective treatment, by removing portions of the chlorine by the section element 14, prior to exposure to the first element 12, treatment can be enhanced. Also, because the ion-exchange sorbent can be generally more effective due to the removal of the chlorine by the second element 14, the ion-exchange sorbent can more effectively remove portions of the lead and some of the remaining VOCs. The small-size carbon, the coconut carbon, and the inorganic filler can also function generally more efficiently and effectively with many contaminants removed from the fluid by the second element 14, before reaching the first element 12.

Additionally, in some embodiments, other treatment parameters also can be decided during this step in the block element combination method. More specifically, in some embodiments, treatment parameters such as fluid flow rate, pore size, and density also can be considered. In some embodiments, the flow rate, the pore size, and the density can at least partially impact the treatment efficacy of the block 10. For example, by manufacturing a less dense second element 14, relative to the first element 12, more of the fluid can enter the second element 14, which, in some embodiments, can enhance contacts between adsorption sites and contaminants in the second element 14. As a result, treatment can be improved relative to blocks comprising substantially different configurations.

Additionally, by employing a larger pore size in the second element 14, relative to the first element 12, more particulates can be adsorbed by the second element 14 so that at least a portion of the particulate content does not contact and clog the pores of the first element 12. Moreover, in some embodiments, the first element 12 can comprise small pores, relative to the second element 14, which can lead to enhanced cyst removal.

Relative to a generally symmetric block, where the compositions, pore sizes, and densities would need to be substantially uniform throughout the block, in some embodiments, the asymmetric block 10 can enhance fluid treatment because these properties can be optimized to ensure an effective flow rate, lack of pore clogging, and more efficient adsorption of contaminants. Furthermore, in some embodiments, life span of the asymmetric blocks can be at least partially increased because of the optimization. For example, in some embodiments, because the pore sizes can be optimized (i.e., larger pore sizes on the second element 14 and smaller pore sizes on the first element 12), more particulate can be adsorbed in the second element 14 so that the smaller pores of the first element 12 can adsorb contaminants like cysts, and not be clogged with the larger particulate matter, which can reduce the operative lifespan of some blocks.

Furthermore, in some embodiments, relative to embodiments comprising symmetric blocks in series, where the compositions, pore sizes, and densities would need to be substantially uniform throughout the blocks, the asymmetric block can exhibit less flow resistance. It can be desirable to install symmetric blocks in series to treat fluid to remove several different types of contaminants in one fluid circulatory system, which some embodiments of the invention can accomplish substantially without a series of blocks. For example, in some embodiments, less flow resistance can be exhibited because the block 10 can incorporate the functionality of the series of symmetric blocks in substantially one unit. This can result in a reduction of treatment components such as tubing, connectors, housings, etc, all of which can lead to increases in flow resistance.

Furthermore, in some embodiments, the more dense elements of the block 10 can generally determine the flow rate because the more dense the section is, the lesser the fluid flow rate through the section. Because, in some embodiments, the first element 12 can comprise the more dense section of the block 10, as previously mentioned, the block 10 can exhibit less flow resistance because the first element 12 can comprise a generally smaller section of the block 10, relative to the block 10 as a whole and the second element 14. As a result, because a smaller portion of the block 10 comprises a higher density, the block 10 can exhibit less flow resistance, which can enhance fluid treatment

Also, in some embodiments, because different densities can create a density gradient between the two elements 12, 14, as previously mentioned, the fluid distribution can be generally more uniformly distributed throughout the block 10 and less pore clogging can occur. The density gradient also can contribute to less flow resistance as a result of the reduction in pore clogging and generally uniform fluid distribution.

Finally, in some embodiments, the finals steps of the block element combination method can comprise manufacturing of the elements 12, 14 according to the determinations made in the previous steps and assembly of the block 10 and cartridge. These steps were previously mentioned. Briefly, in some embodiments, the elements 12, 14 can be manufactured to achieve desired treatment profiles using a variety of manufacturing techniques including, but not limited to sintering, molding, and extrusion. Next, the elements 12, 14 can be substantially assembled to form the block 10, and the block 10 can be installed, along with a cartridge, into a fluid circulatory system for fluid treatment.

### EXAMPLES

The following examples and experimental results are included to provide those of ordinary skill in the art with a complete disclosure and description of particular manners in which some embodiments of the present invention can be practiced and evaluated, and are not intended to limit the scope of the invention.

### Example One

Example one illustrates an embodiment of the block element combination method. First, it was determined that a fluid contained VOCs and cysts, and that activated coal carbon, resin binder, and diatomaceous earth would be suitable constituents to treat the fluid. It was then determined that a suitable sequence to treat the fluid containing these contaminants was to prepare a relatively low density second element containing activated carbon and resin binder to remove a portion of the VOCs and a relatively high density first element containing the activated coal carbon, resin binder, and diatomaceous earth to remove another portion of the VOCs and some of the cysts.

After making a determination of the objects of the treatment and the treatment sequence, the elements were manufactured. The first element and the second element were separately extruded. The first element was extruded under low back-pushing pressure and a relatively high speed of the extruder screw. The second element was extruded under high back-pushing pressure and a relatively low speed of the extruder screw. This manufacturing gave rise to a smaller first element (inside diameter 0.375″; outside diameter 1.00″) with a relatively high density and a larger second element (inside diameter 1.00″; outside diameter 2.120″) with a relatively low density. After manufacturing, the first element was inserted into the second element, to form the block.

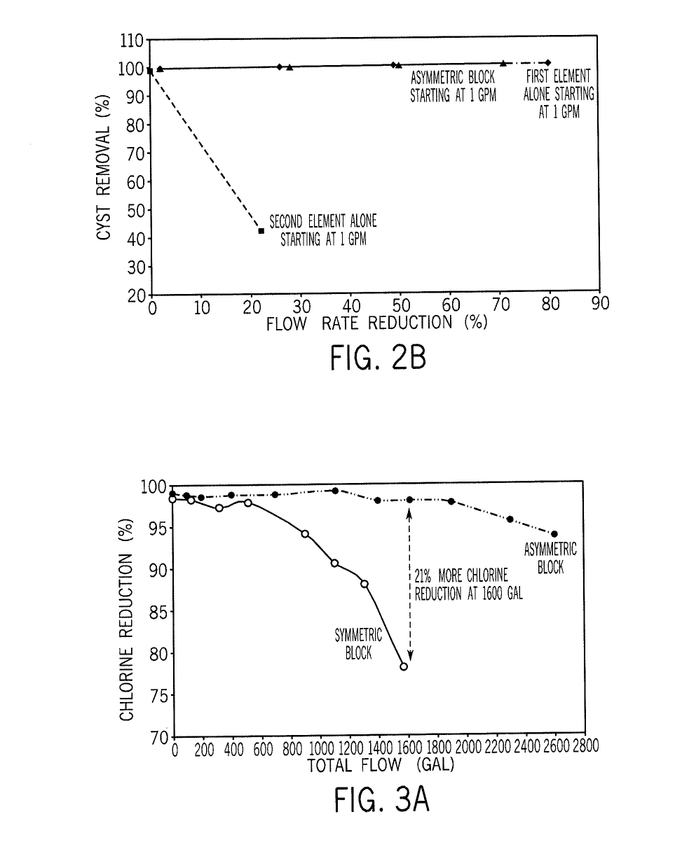

To determine the effectiveness of the asymmetric block and the block element combination method, the asymmetric block prepared as described above was compared to its constituent elements (i.e., first element v. second element v. asymmetric block comprising the first element and the second element). The results illustrate that the asymmetric block is more effective at removing VOCs and cysts than the separate elements. For example, referring to FIG. 2B, at a flow rate of 0.78 gpm (gallons per minute), the second element alone removed only 42.4% of the cysts in the fluid. However, both the asymmetric block and the first element alone removed 100% of the cysts at the same rate and over a range of other flow rates. Additionally, as shown in FIG. 2A, after 100 gallons of contaminated fluid passed through the samples, the asymmetric block removed 93.5% of the VOCs, however, the first element and the second element removed only 55.1% and 86.8%, respectively. As illustrated in FIGS. 2A and 2B, over a range of flow rates and other conditions, the asymmetric block generally performs better at treating the test fluid. Together, these results show that the synergy of combination of the first element and the second element in the asymmetric block leads to enhanced fluid treatment relative to blocks comprising only one element and/or treatment profile.

### Example Two

Example two illustrates an embodiment of the block element combination method. First, it was determined that a fluid contained chlorine, large and small particulate matter, lead, VOCs, cysts, and that activated coal carbon, coconut carbon, ion-exchange sorbent, small-size carbon, an inorganic filler, such as diatomaceous earth, and a polymer resin binder, and would be the suitable constituents to treat the fluid. It was then determined that a suitable sequence to treat the fluid containing these contaminants was to prepare a relatively low density second element containing activated carbon and resin binder to remove a portion of the chlorine, a portion of the VOCs, and a portion of the large and small particulate matter and a relatively high density first element containing the coconut carbon, ion-exchange sorbent, small-size carbon, a polymer resin binder, and diatomaceous earth to remove another portion of the VOCs, another portion of the particulate matter, lead, and some of the cysts.

After making a determination of the objects of the treatment and the treatment sequence, the elements were manufactured. The first element and the second element were separately extruded. The first element was extruded under low back-pushing pressure and a relatively high speed of the extruder screw. The second element was extruded under high back-pushing pressure and a relatively low speed of the extruder screw. This manufacturing gave rise to a smaller first element with a relatively high density and a larger second element with a relatively low density. After manufacturing, the first element was inserted into the second element, to form the block.

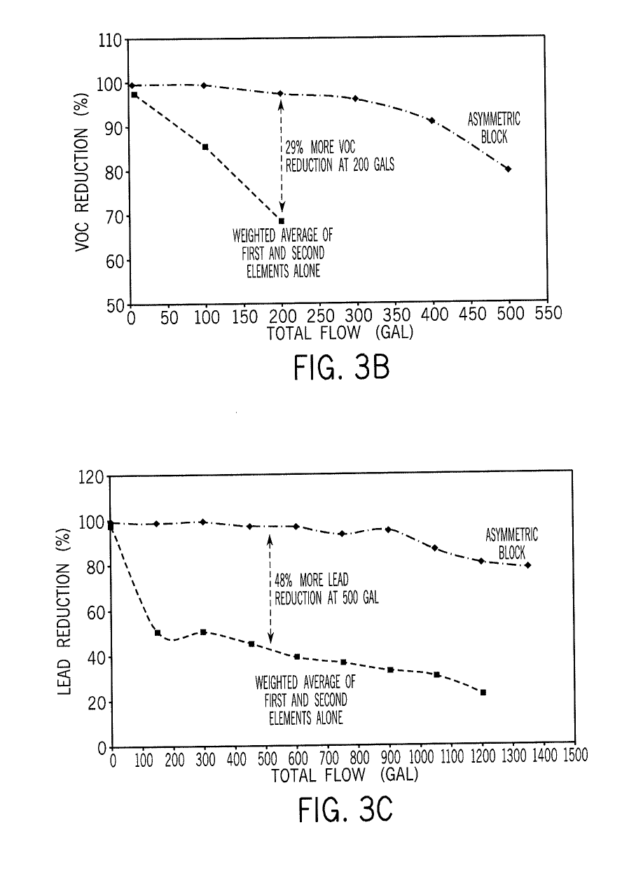

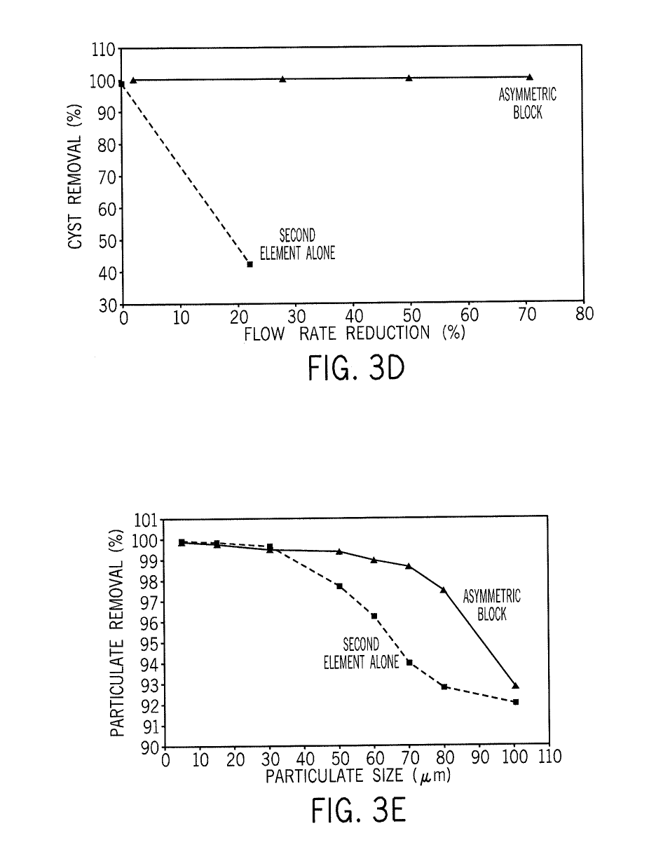

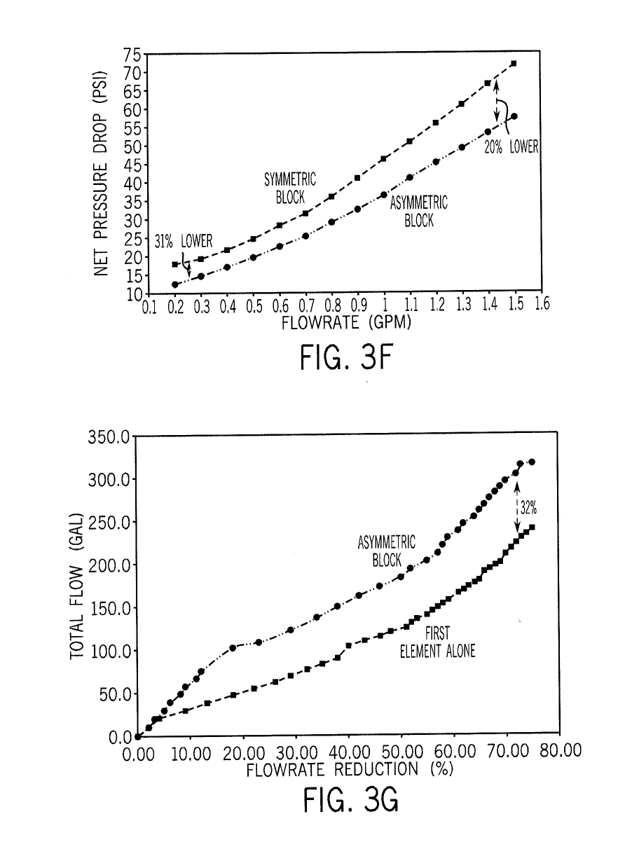

To determine the effectiveness of the asymmetric block and the block element combination method, the asymmetric block prepared as described above was compared to different control blocks, as more specifically described below. As illustrated in FIGS. 3A-3G, the results show that the asymmetric block is more effective at removing a substantial portion of the contaminants than are the controls.

For example, as shown in FIG. 3A, when compared to a symmetric block of similar overall density, overall size, and overall wall thickness, the asymmetric block removed 21% more chlorine relative to the symmetric block. Further, as shown in FIG. 3B, when compared to a weighted average of data from measurements of the first and the second elements alone, after 1600 gallons of contaminated fluid passed through the sample blocks, the asymmetric block removed 29% more VOCs relative to the control blocks. Also, referring to FIG. 3C, when compared to a weighted average of data from measurements of the first and the second elements alone, after 500 gallons of contaminated fluid passed through each sample block, the asymmetric block removed 48% more lead.

Additionally, compared to a symmetric block similar in composition to only to the second element, the asymmetric block removed 100% of the cysts, while the symmetric block removed only about 40% of the cysts, as shown in FIG. 3D. The asymmetric block also enhanced particulate removal and manifested a lower flow resistance, relative to a symmetric block of similar overall density, overall size, and overall wall thickness, which could be at least partially the reason why the asymmetric block produced better treatment results than the symmetric block, as shown in FIGS. 3E and 3F. Finally, the asymmetric block continued to function for longer than the symmetric block. As shown in FIG. 3G, the service life of the asymmetric block extended 32% longer than that of the service life of a symmetric block similar in composition to only to the first element. Together these results show that the synergy of the combination of the first element and the second element in the asymmetric block leads to enhanced fluid treatment and service life.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed. The entire disclosure of each patent and publication cited herein is incorporated by reference, as if each such patent or publication were individually incorporated by reference herein. Various features and advantages of the invention are set forth in the following claims.

1. An asymmetric activated carbon block comprising:
a first element, the first element comprising at least two constituents; and
a second element,
at least a portion of the first element positioned substantially within the second element so that a part of the first element is located immediately adjacent to the second element,
the second element comprising at least two constituents, at least one of the at least two constituents of the second element differs from at least one of the at least two constituents of the first element, and
the first element and the second element are asymmetric with respect a structural property.

2. The asymmetric activated carbon block of claim 1, and further comprising a cartridge, at least a portion of the first element and the second element positioned substantially within the cartridge.

3. The asymmetric activated carbon block of claim 1, wherein the first element comprises a first treatment profile and the second element comprises a second treatment profile.

4. The asymmetric activated carbon block of claim 3, wherein the first treatment profile and the second treatment profile are different.

5. The asymmetric activated carbon block of claim 1, wherein an outer diameter of the first element is substantially equal to an inner diameter of the second element.

6. The asymmetric activated carbon block of claim 1, wherein the first element comprises a first density and the second element comprises a second density, wherein the first density is generally different than the second density.

7. The asymmetric activated carbon block of claim 1, wherein the second element is capable of being manufactured independent of the first element.

8. The asymmetric activated carbon block of claim 1, wherein the asymmetric carbon block comprises distal ends and portions of the distal ends are substantially sealed.

9. A block element combination method for treating a fluid comprising contaminants, the method comprising:
selecting at least two treatment profiles that can treat a portion of the fluid comprising contaminants;
determining a treatment sequence of the treatment profiles;
independently manufacturing a first element and a second element; and
positioning the first element and the second element so that a part of the first element is located immediately adjacent to the second element, and so that the treatment profiles are arranged in the treatment sequence, wherein the at least two treatment profiles are different.

10. The method of claim 9, wherein manufacturing comprises at least one of extruding, molding, sintering, and gluing.

11. The method of claim 10, wherein the first element and the second element are manufactured by two different methods of manufacturing.

12. The method of claim 9, wherein the manufacturing comprises manufacturing conditions including temperature, pressure, and speed; and
wherein the manufacturing conditions of the first element and the manufacturing conditions of the second element differ with respect to at least one of the temperature, the pressure, and the speed.

13. The method of claim 9, and further comprising inserting a portion of the first element into the second element so that an inner diameter of the second element and an outer diameter of the first element are immediately adjacent.

14. The method of claim 13, and further comprising inserting the first element and the second element into a cartridge, coupling the cartridge to a fluid circulatory system, and circulating a fluid through the cartridge.

15. The method of claim 9, and further comprising determining an identity of the contaminants before selecting the at least two treatment profiles.

16. The method of claim 15, wherein the treatment sequence is at least partially determined by at least one of the identity of the contaminants in the fluid and the selected treatment profiles.

17. An asymmetric activated carbon block comprising:
a first element comprising a first treatment profile, the first element including a first element channel; and
a second element comprising a second treatment profile, the second element including a second element channel,
the second element capable of being manufactured independent of the first element,
a portion of the first element positioned within the second element channel of the second element so that a part of the first element is immediately adjacent to the second element, and
the first treatment profile and the second treatment profile are different.

18. The asymmetric activated carbon block of claim 17, wherein the first element and the second element comprise generally different densities and generally different compositions.

19. The asymmetric activated carbon block of claim 17, and further comprising a cartridge, at least a portion of the first element and the second element positioned within the cartridge.

20. The asymmetric activated carbon block of claim 17, wherein the first element and the second element are both configured for at least physical adsorption and electrokinetic adsorption.
